(19) United States
(12) Patent Application Publication
(10) Pub. No.: US 2026/0080849 A1
(43) Pub. Date: Mar. 19, 2026

(54) MUSICAL INSTRUMENT BOW DEVICE AND METHOD

(71) Applicant: Michael Wade McCullough, Toronto (CA)

(72) Inventor: Michael Wade McCullough, Toronto (CA)

(21) Appl. No.: 19/329,405

(22) Filed: Sep. 15, 2025

Related U.S. Application Data
(60) Provisional application No. 63/694,408, filed on Sep. 13, 2024.

(51) Int. Cl. G10D 3/16

(52) U.S. Cl. CPC G10D 3/16

(57) ABSTRACT

A bow device includes a stick, a frog, a loop, and/or a hair portion. The stick has distal tip and proximal end portions. The frog and loop engage the proximal end portion, with the loop between the frog and the distal tip portion. The hair portion is tautly held between the frog and the distal tip portion for selectively engaging strings of a musical instrument for sliding relative movement. The frog and loop passively engage a user's fingers between the stick and the hair portion. When the bow device is removed from the strings, it is still secured to the user's fingers ready to selectively re-engage the strings, while the user's fingers are free to pluck/strum the strings. The bow device enables ready transitions between bowing techniques and plucking/strumming techniques, without adjusting the user's secure engagement of the bow device.

### FIELD OF THE INVENTION

The present invention relates generally to musical instrument bows and, more particularly, to a musical instrument bow device, system, and methods.

### BACKGROUND OF THE INVENTION

Stringed instruments may have been around since ancient times, for example, since the ancient Egyptian and/or Hellenic civilizations. However, techniques of bowing such instruments may have only developed during relatively recent periods, for example, perhaps since about the 8th century. In modern times, the vast majority of traditional bows may still be used with violins, violas, cellos, and/or bass instruments. Yet, bows may have been used with modern stringed instruments (e.g., guitars, banjos, mandolins) for a number decades, for example, as popularized by Led Zeppelin guitarist Jimmy Page, among others.

Prior art bows may have been poorly adapted for use with instruments that are normally plucked or strummed. Typically, during use, a prior art bow may occupy a musician's entire hand. As such, it may have been difficult and/or awkward for the musician to, substantially contemporaneously, transition to plucking and/or strumming the strings of the instrument (e.g., guitar, banjo, mandolin) without also adjusting their grip or dropping the bow. Prior art bows may have been cumbersome and/or imposed limited functionalities when used with guitars, banjos, mandolins, or other stringed instruments that are principally adapted for plucking or strumming.

It may have been somewhat difficult and/or awkward to hold or grip a prior art bow, by its stick portion, at an optimal angle (e.g., 90 degrees) relative to the strings of a guitar, banjo, mandolin, or other stringed instrument that is principally adapted for plucking or strumming.

Musical instrument bows include a hair portion, which may need to be replaced (or “re-haired”) from time to time. Prior art bows may have been somewhat difficult to re-hair, requiring significant skill or expertise. Musicians may have been limited in their ability to re-hair their own bows, instead requiring the services of professional luthiers for maintenance in this respect.

In the prior art, certain bows or bow-like devices may have been somewhat adapted for use with guitars, banjos, mandolins, or other stringed instruments that are conventionally plucked or strummed. For example, Pickaso Innovations LLC (of New York) offers a bow-like device that is adapted for use with guitars. The Pickaso device, however, may need to be grasped by a musician's fingers, and/or may limit a range of playing techniques that cannot otherwise be used contemporaneously. The Pickaso device may be relatively short and/or may restrict a musician's ability to play chords and/or long/sustained notes. Also, the Pickaso bow may have limited versatility and/or only be adapted for use with instruments that have sound holes (e.g., acoustic guitars). The Pickaso device or other specially-adapted bows/bow-like devices may have been somewhat expensive, or may have involved a somewhat steep learning curve to use them, and their widespread adoption may have suffered accordingly. What may be needed is a bow for use with bowing techniques, which is also adapted for substantially seamless transition for plucking/strumming techniques, and has a comparable cost to a violin bow, with a similar learning curve.

Prior art bows may have imposed limitations on musicians'playing styles and/or on the sounds that could be generated in use with guitars, banjos, mandolins, or other stringed instruments that are principally adapted for plucking or strumming.

The prior art may have included combination or dual bow-and-pick devices for transitioning between bowing and picking, but these may have imposed limitations on techniques that could be used by the musician.

Previous systems or methods for re-hairing bows may have been somewhat complex and/or may have required a relatively deep understanding. These and other factors may have made it somewhat difficult to re-hair prior art bows without aid of professional luthiers.

Prior art bows may have done little to help musicians efficiently switch between bowing and plucking/strumming. If it was even possible to switch or transition between such modes at all, an inordinate amount of time or effort may have been required—or it may have been cumbersome or awkward—to do so.

In view of all the foregoing, there may be a need for a device, system, and/or method which enables and/or facilitates the use of bowing techniques with stringed instruments that are traditionally plucked or strummed. Preferably, such a device, system, and/or method may enable and/or help musicians to readily/seamlessly transition or switch their bowing hand between bowing and more traditional instrument articulations and/or playing techniques (e.g., strumming or plucking). Musicians and music enthusiasts may benefit from devices, systems, and/or methods which enable or facilitate new modes of musical expression, sounds, and/or techniques.

It may be an object of the invention to provide one or more musical instrument bow devices, systems, and/or methods.

It may be an object of the invention to provide a bow device, system, and/or method for use with musical instruments which were typically, in the prior art, plucked or strummed—such as, for example, guitars, banjos, and/or mandolins.

It may be an object according to one aspect of the invention to provide a bow device, system, and/or method that enables or facilitates a reduction in the amount of time required to transition between bowing and plucking/strumming.

It may be an object according to one aspect of the invention to provide a device, system, and/or method for passively and securely holding a bow, at the ready, between the webbing of a user's fingers whilst still enabling and/or facilitating conventional plucking and/or strumming techniques by the user.

It may be an object according to one aspect of the invention to provide a device, system, and/or method that enables and/or helps a bow to be readily grasped by a user, while being drawn/moved (a) in a substantially vertically direction, and/or (b) at a substantially 90-degree angle, perpendicular to a musical instrument's strings.

It may be an object according to one aspect of the invention to provide a bow device, system, and/or method that may enable and/or aid in achieving a preferred tone production.

It may be an object according to one aspect of the invention to provide a bow device, system, and/or method that may be used on instruments with and without sound holes.

It may be an object according to one aspect of the invention to provide a bow device, system, and/or method that enables and/or aids a user in playing chords and/or long/sustained notes.

It may be an object according to one aspect of the invention to provide a bow device, system, and/or method that enables or helps the bow to be readily re-haired.

It may be an object according to one aspect of the invention to provide a bow device, system, and/or method that enables and/or facilitates use with premade hair ribbons.

It may be an object according to one aspect of the invention to provide bow device, system, and/or method that readily enables and/or facilitates a relatively simple and/or straightforward re-hairing, preferably by a layman and/or without need for a skilled luthier.

It may be an object according to one aspect of the invention to provide a bow device, system, and/or method that enables and/or facilitates use of a relatively wide variety of playing styles and/or a relatively wide variety of musical sounds.

It is an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a musical instrument bow device, which preferably includes a stick member, a frog member, a loop member, and/or a hair portion. The stick member preferably has a distal tip portion and a proximal end portion. Preferably, the frog member securely engages the proximal end portion. Preferably, the loop member securely engages the proximal end portion, preferably between the frog member and the distal tip portion. Preferably, the hair portion is substantially tautly and securely engaged between the frog member and the distal tip portion. The hair portion is preferably adapted to selectively engage one or more strings of a musical instrument for sliding movement relative thereto. The frog member and the loop member are each preferably adapted to passively and securely engage a respective one of a user's fingers, preferably between the stick member and the hair portion. Preferably, when the bow device is removed from the strings, the bow device is still secured to the user's fingers, preferably at the ready to selectively re-engage the strings, while the user's fingers are preferably free to selectively pluck and/or strum the strings. The bow device preferably enables ready transitions between bowing techniques and plucking and/or strumming techniques, preferably without adjusting the user's secure engagement of the bow device.

According to an aspect of the invention, the frog member and the loop member may preferably, but need not necessarily, be spaced apart from one another. The frog member may preferably, but need not necessarily, be adapted to passively and securely engage the user's index finger. The loop member may preferably, but need not necessarily, be adapted to passively and securely engage the user's ring finger. The frog member and the loop member may preferably, but need not necessarily, be adapted such that, preferably when the user spreads their fingers wide, the hair portion may preferably, but need not necessarily, be adapted to selectively engage the strings of the musical instrument for sliding movement relative thereto.

According to an aspect of the invention, the frog member may preferably, but need not necessarily, have a crook portion. The crook portion may preferably, but need not necessarily, be adapted to engage the user's thumb.

According to an aspect of the invention, the distal tip portion may preferably, but need not necessarily, be shaped to define a bifurcated tip notch. The hair portion may preferably, but need not necessarily, extend between the bifurcated tip notch. The hair portion may preferably, but need not necessarily, frictionally engage the bifurcated tip notch, preferably to keep the hair portion taut.

According to an aspect of the invention, the distal tip portion may preferably, but need not necessarily, be shaped to define a tip eyelet. The frog member may preferably, but need not necessarily, be shaped to define a frog eyelet. Opposing ends of the hair portion may preferably, but need not necessarily, be provided with a frog aglet and a tip aglet. Preferably, the tip aglet may securely engage the tip eyelet. Preferably, the frog aglet may securely engage the frog eyelet. The hair portion may preferably, but need not necessarily, be securely engaged between the frog eyelet and the tip eyelet.

According to an aspect of the invention, the tip aglet may preferably, but need not necessarily, removably engage the tip eyelet. The frog aglet may preferably, but need not necessarily, removably engage the frog eyelet. The tip eyelet, the frog eyelet, and the hair portion may preferably, but need not necessarily, together enable a simple and/or straightforward re-hairing of the bow device.

According to an aspect of the invention, the frog eyelet may preferably, but need not necessarily, be shaped in a bottom portion of the frog member.

According to an aspect of the invention, the proximal end portion and the frog member may preferably, but need not necessarily, include fastening means for securing the stick member to the frog member.

According to an aspect of the invention, the fastening means may preferably, but need not necessarily, include a screw provided on the proximal end portion and/or a nut member on the frog member.

According to an aspect of the invention, the proximal end portion may preferably, but need not necessarily, be shaped to define a frog notch. The nut member may preferably, but need not necessarily, extend through the frog notch. The nut member may preferably, but need not necessarily, engage the screw provided on the proximal end portion.

According to an aspect of the invention, the frog member may preferably, but need not necessarily, be shaped to define a stick hole and/or a nut hole. The stick member may preferably, but need not necessarily, be shaped to define a screw hole. Channels may preferably, but need not necessarily, be shaped in association with each of the stick hole, the nut hole, and/or the screw hole. The channels may preferably, but need not necessarily, serve as connection paths for the nut member and/or the screw to secure the stick member to the frog member.

According to an aspect of the invention, the hair portion may preferably, but need not necessarily, include a prefabricated band of horsehair.

According to an aspect of the invention, the stick member may preferably, but need not necessarily, be constructed from one or more wood materials.

According to an aspect of the invention, the loop member may preferably, but need not necessarily, be constructed from one or more rope-like and/or cord-like materials.

According to an aspect of the invention, the frog member may preferably, but need not necessarily, be about 7 centimeters long and/or about 6 centimeters high.

According to the invention, there is also disclosed a method for manufacturing a musical instrument bow device. The method preferably includes step (a), step (b), and/or step (c). Preferably, in step (a), a stick member is provided. The stick member preferably has a distal tip portion and a proximal end portion. Preferably, in step (b), a frog member and/or a loop member are provided. Preferably, the frog member and the loop member are securely engaged on the proximal end portion. Preferably, in step (c), a hair portion is provided. Preferably, the hair portion is substantially tautly and securely engaged between the frog member and/or the distal tip portion. The frog member and the loop member are preferably each adapted to passively and securely engage a respective one of a user's fingers, preferably between the stick member and the hair portion. Preferably, when the bow device is removed from the strings, the bow device is still secured to the user's fingers, at the ready to selectively re-engage the strings, while the user's fingers are preferably free to selectively pluck and/or strum the strings. The bow device preferably enables ready transitions between bowing techniques and plucking and/or strumming techniques, preferably without adjusting the user's secure engagement of the bow device.

According to an aspect of the invention, in step (a), the distal tip portion may preferably, but need not necessarily, be shaped to define a bifurcated tip notch. In step (c), the hair portion may preferably, but need not necessarily, extend between the bifurcated tip notch. The hair portion may preferably, but need not necessarily, frictionally engage the bifurcated tip notch, preferably to keep the hair portion taut.

According to an aspect of the invention, the distal tip portion may preferably, but need not necessarily, be shaped to define a tip eyelet. The frog member may preferably, but need not necessarily, be shaped to define a frog eyelet. Opposing ends of the hair portion may preferably, but need not necessarily, be provided with a frog aglet and a tip aglet. Preferably, in step (c), the tip aglet may securely engage the tip eyelet, and the frog aglet may securely engage the frog eyelet. The hair portion may preferably, but need not necessarily, be securely engaged between the frog eyelet and the tip eyelet.

According to an aspect of the invention, preferably, in step (c), the tip aglet may removably engage the tip eyelet, and the frog aglet may removably engage the frog eyelet. The tip eyelet, the frog eyelet, and/or the hair portion may preferably, but need not necessarily, together enable a simple and/or straightforward re-hairing of the bow device.

According to an aspect of the invention, the method may preferably, but need not necessarily, include further steps, preferably before step (c), of forming aglets on opposing ends of the hair portion. In these steps, a piece of heat shrinkable tubing may preferably, but need not necessarily, be slid over each of the opposing ends of the hair portion. The tubing may preferably, but need not necessarily, be shrunk with a heat gun or hair dryer, preferably such that the tubing engages the hair portion. The tubing and/or the hair portion may preferably, but need not necessarily, be trimmed to an appropriate length. A fast-drying adhesive may preferably, but need not necessarily, be applied to securely bond the tubing to the hair portion, and to securely bond the hair together.

Also, in another summary of the invention, there are disclosed one or more musical instrument bow devices, systems, and/or methods which integrate a stick member, a frog member, a loop member, and a hair portion. Together, they preferably enable and/or facilitate versatile ways of playing stringed instruments by bowing, plucking, and/or strumming. The stick member may preferably have a distal tip portion and proximal end portion. The frog member and the loop member may preferably securely engage the proximal end portion, with each adapted to securely engage a respective one of the user's fingers. The hair portion may preferably be substantially taut, in secure engagement between the frog member and the tip portion of the stick member, and adapted to selectively engage one or more strings of a musical instrument for sliding movement relative thereto. According to the invention, preferably when the bow device is removed from the strings, it is preferably still secured to the user's fingers, at the ready to selectively re-engage the strings, while the user's fingers are preferably free to selectively pluck and strum the strings as desired.

According to an aspect of the invention, the proximal end portion of the stick member may preferably, but need not necessarily, have stick fastening means for securing it to the frog member. The stick fastening means may preferably, but need not necessarily, include a screw.

According to an aspect of the invention, the frog member may preferably, but need not necessarily, have frog fastening means for securing it to the stick member. The frog fastening means may preferably, but need not necessarily, include a nut member.

According to an aspect of the invention, the proximal end portion may preferably, but need not necessarily, be shaped to define a frog notch. The frog fastening means may preferably, but need not necessarily, secure the frog member to the frog notch of the stick member.

According to an aspect of the invention, the tip portion of the stick member may preferably, but need not necessarily, be shaped to define a tip notch with a tip eyelet. The frog member may preferably, but need not necessarily, be shaped to define a frog eyelet. Opposing ends of the hair portion may preferably, but need not necessarily, be provided with a frog aglet and a tip aglet. The tip aglet may preferably, but need not necessarily, securely engage the tip eyelet. The frog aglet may preferably, but need not necessarily, securely engage the frog eyelet. The hair portion may preferably, but need not necessarily, thus be securely engaged between the frog eyelet and the tip eyelet.

According to an aspect of the invention, a stick member may preferably, but need not necessarily, be constructed of one or more wood materials.

According to an aspect of the invention, the nut member may preferably, but need not necessarily, attach to the top of the stick member via nut holes through the top of the frog member and the stick member. The frog member may preferably, but need not necessarily, securely engage the stick member in this manner.

According to an aspect of the invention, the nut hole through the top of the frog member may preferably, but need not necessarily, be sized and/or adapted to provide ample space for movement of the user's hand during use of the bow device as aforesaid.

According to an aspect of the invention, the screw may preferably, but need not necessarily, securely engage the proximal end portion of the stick member via one or more screw holes in the proximal end portion and/or in the frog member. The stick member may preferably, but need not necessarily, securely engage the frog member in this manner.

According to an aspect of the invention, the loop member may preferably, but need not necessarily, help the user to selectively engage the strings of the musical instrument for sliding movement relative thereto.

According to an aspect of the invention, the loop member may preferably, but need not necessarily, be constructed of one or more rope-and/or cord-like materials.

According to an aspect of the invention, the loop member may preferably, but need not necessarily, help the user to maintain the bow device in place and at the ready as aforesaid.

According to an aspect of the invention, the hair portion may preferably, but need not necessarily, include a prefabricated band of horsehair.

According to an aspect of the invention, the frog eyelet may preferably, but need not necessarily, be shaped into a bottom portion of the frog member, for example, by machining.

According to an aspect of the invention, the tip notch may preferably, but need not necessarily, include a bifurcated tip. The tip notch and the tip eyelet may preferably, but need not necessarily, help keep the hair portion taut, for example, via frictional engagement.

According to an aspect of the invention, the tip notch and the tip eyelet may preferably, but need not necessarily, securely engage the hair portion free and clear of any wedges that otherwise may need to be cut into the bow device.

According to an aspect of the invention, the frog member may preferably, but need not necessarily, enable the bow device to passively and securely engage the user's finger between the stick member and the hair portion.

According to an aspect of the invention, the hair portion may preferably, but need not necessarily, enable and/or facilitate a relatively simple and/or straightforward method for re-hairing of the bow device.

According to an aspect of the invention, the hair portion, the tip eyelet, and/or the frog eyelet may preferably, but need not necessarily, be sized and/or adapted to readily enable and/or facilitate re-hairing of the bow device, perhaps at least partially without involvement of a luthier.

According to an aspect of the invention, the frog component may preferably, but need not necessarily, be sized and/or adapted to enable and/or facilitate the bow device being passively and securely engaged by the user's hand for playing a musical instrument without encumbering or restricting the user's fingers from traditional plucking and/or strumming techniques.

According to an aspect of the invention, the bow device, system, and/or method may preferably, but need not necessarily, enable and/or facilitate ready transitions between bowing techniques and plucking/strumming techniques, without adjusting the user's secure engagement of the bow device.

According to the invention, the bow device, system, and/or method may preferably, but need not necessarily, enable and/or help increase convenience and/or versatility associated with bows and musical instruments—e.g., as compared to prior art bows. The bow device, system, and/or method may preferably, but need not necessarily, enable and/or help (a) increase availability of bows in the market, (b) increase versatility of bows'uses with musical instruments, and/or (c) simplify procedures for re-hairing bows.

Persons skilled in the art will appreciate in view of the teachings and disclosures herein that the bow device, system, and/or method, according to the invention, may offer one or more significant advantageous utilities and/or functionalities in comparison to the prior art.

Other advantages, features, and/or characteristics of the present invention, as well as methods of operation and functions of the related elements of the structure, operation, and/or the combination of parts, features, and/or economies of manufacture, will become more apparent upon consideration of the detailed description with reference to the figures which accompany this application.

### BRIEF DESCRIPTION OF THE DRAWINGS

The novel features which are believed to be characteristic of the present invention, and related devices, systems, and/or methods according to the present invention, as to their structure, organization, use, and/or methods of manufacture and/or operation, together with further objectives and advantages thereof, may be better understood from the figures which accompany this application, in which presently preferred embodiments of the invention have been illustrated by way of example. It is expressly understood, however, that such figures have been provided for the purpose of illustration and/or description only, and not intended as a definition of the limits of the invention. In the accompanying drawings:

FIG. 1 is a left side elevational view of a bow device according to a preferred embodiment of the invention;

FIG. 2 is a right side elevational view of the bow device of FIG. 1;

FIG. 3 is a bottom plan view of the bow device of FIG. 1;

FIG. 4 is a top plan view of the bow device of FIG. 1;

FIG. 5 is a left side partially exploded view of the bow device of FIG. 1;

FIG. 6 is a left side partially phantom view of the bow device of FIG. 1;

FIG. 7 is a right side partially phantom view of the bow device of FIG. 1;

FIG. 8 is a front elevational view of the bow device of FIG. 1;

FIG. 9 is a back elevational view of the bow device of FIG. 1;

FIG. 10 is a left side elevational view of a stick member of the bow device of FIG. 1;

FIG. 11 is a bottom plan view of the stick member of FIG. 10;

FIG. 12 is a top plan view of the stick member of FIG. 10;

FIG. 13 is a right side elevational view of the stick member of FIG. 10;

FIG. 14 is a front elevational view of the stick member of FIG. 10;

FIG. 15 is a back view of the stick member of FIG. 10;

FIG. 16 is a right side elevational view of a frog member of the bow device of FIG. 1;

FIG. 17 is a left side elevational view of the frog member of FIG. 16;

FIG. 18 is a top plan view of the frog member of FIG. 16;

FIG. 19 is a bottom plan view of the frog member of FIG. 16;

FIG. 20 is a front elevational view of the frog member of FIG. 16;

FIG. 21 is a back elevational view of the frog member of FIG. 16;

FIGS. 22 to 29 depict successive steps in a method of using the bow device of FIG. 1 according to a preferred embodiment of the invention; such that FIG. 22 depicts a first step, FIG. 23 depicts a second step, FIG. 24 depicts a third step, FIG. 25 depicts a fourth step, FIG. 26 depicts a fifth step, FIG. 27 depicts a sixth step, FIG. 28 depicts a seventh step, and FIG. 29 depicts an eighth step; all in the aforesaid method of using the bow device; and

FIGS. 30-69 depict successive steps in a method of hairing / re-hairing the bow device of FIG. 1 according to a preferred embodiment of the invention; such that FIG. 30 depicts a first step, FIG. 31 depicts a second step, FIG. 32 depicts a third step, FIG. 33 depicts a fourth step, FIG. 34 depicts a fifth step, FIG. 35 depicts a sixth step, FIG. 36 depicts a seventh step, FIG. 37 depicts an eighth step, FIG. 38 depicts a ninth step, FIG. 39 depicts a tenth step, FIG. 40 depicts an eleventh step, FIG. 41 depicts a twelfth step, FIG. 42 depicts a thirteenth step, FIG. 43 depicts a fourteenth step, FIG. 44 depicts a fifteenth step, FIG. 45 depicts a sixteenth step, FIG. 46 depicts a seventeenth step, FIG. 47 depicts an eighteenth step, FIG. 48 depicts a nineteenth step, FIG. 49 depicts a twentieth step, FIG. 50 depicts a twenty-first step, FIG. 51 depicts a twenty-second step, FIG. 52 depicts a twenty-third step, FIG. 53 depicts a twenty-fourth step, FIG. 54 depicts a twenty-fifth step, FIG. 55 depicts a twenty-sixth step, FIG. 56 depicts a twenty-seventh step, FIG. 57 depicts a twenty-eighth step, FIG. 58 depicts a twenty-ninth step, FIG. 59 depicts a thirtieth step, FIG. 60 depicts a thirty-first step, FIG. 61 depicts a thirty-second step, FIG. 62 depicts a thirty-third step, FIG. 63 depicts a thirty-fourth step, FIG. 64 depicts a thirty-fifth step, FIG. 65 depicts a thirty-sixth step, FIG. 66 depicts a thirty-seventh step, FIG. 67 depicts a thirty-eighth step, FIG. 68 depicts a thirty-ninth step, and FIG. 69 depicts a fortieth step; all in the aforesaid method of hairing/re-hairing the bow device.

### DETAILED DESCRIPTION OF PREFERRED EMBODIMENTS

This disclosure, including the accompanying figures, may include or reference one or more dimensions, numbers, materials of construction, words, phrases, sentences, arrangements, and/or configurations which may be included by way of example. It may bear repeating, in this respect specifically, that such figures and/or any such aspects of this disclosure are for the purpose of illustration and description only, and not intended as a definition of the limits of the invention.

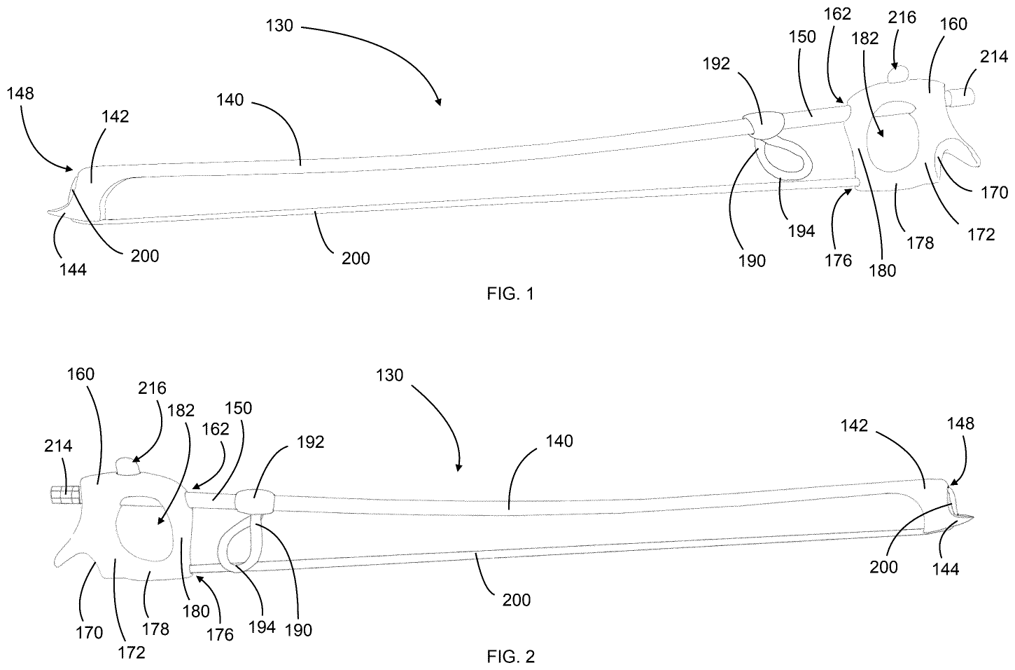

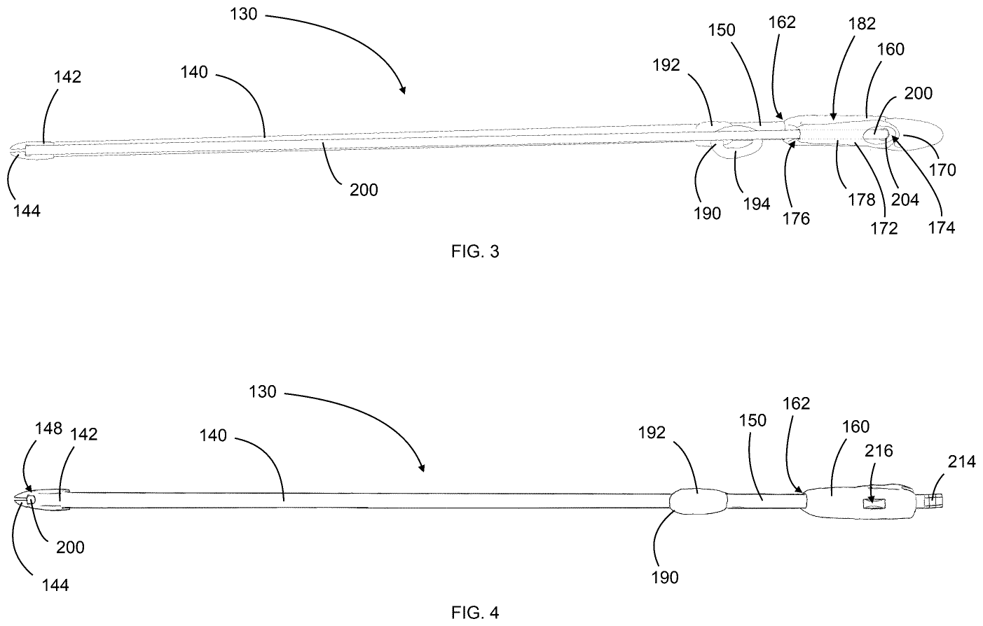

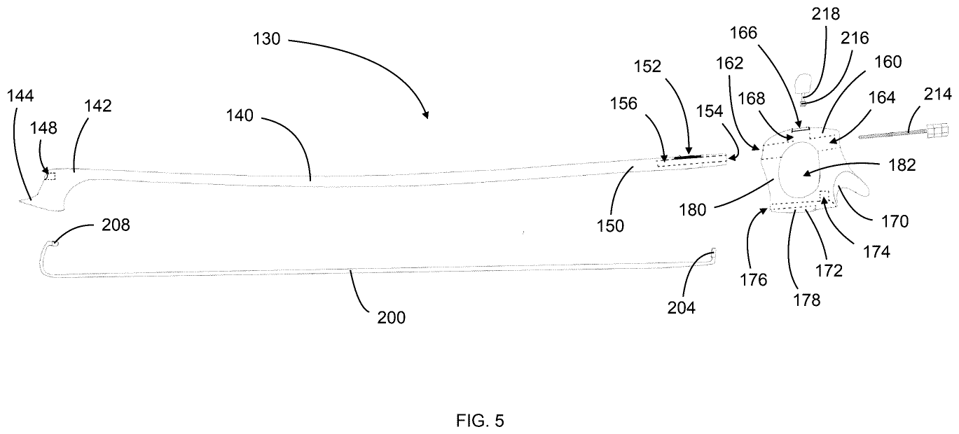

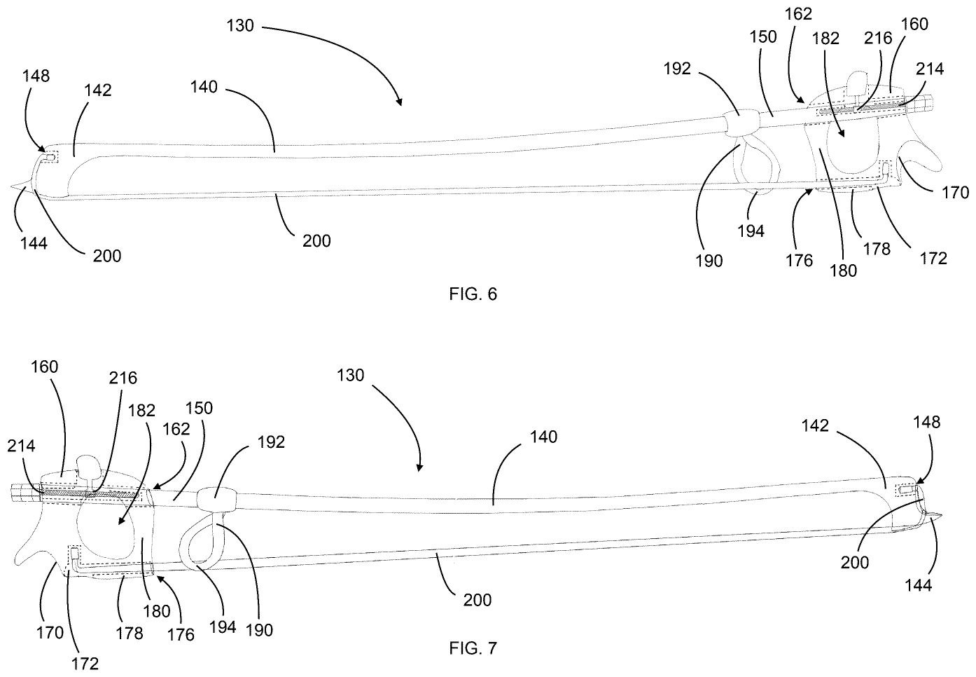

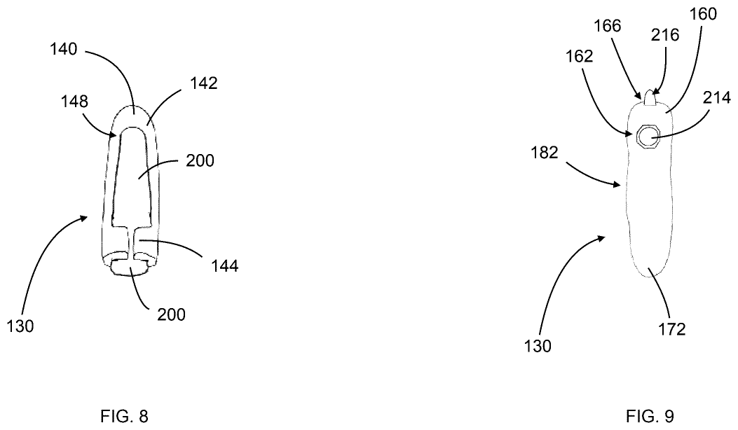

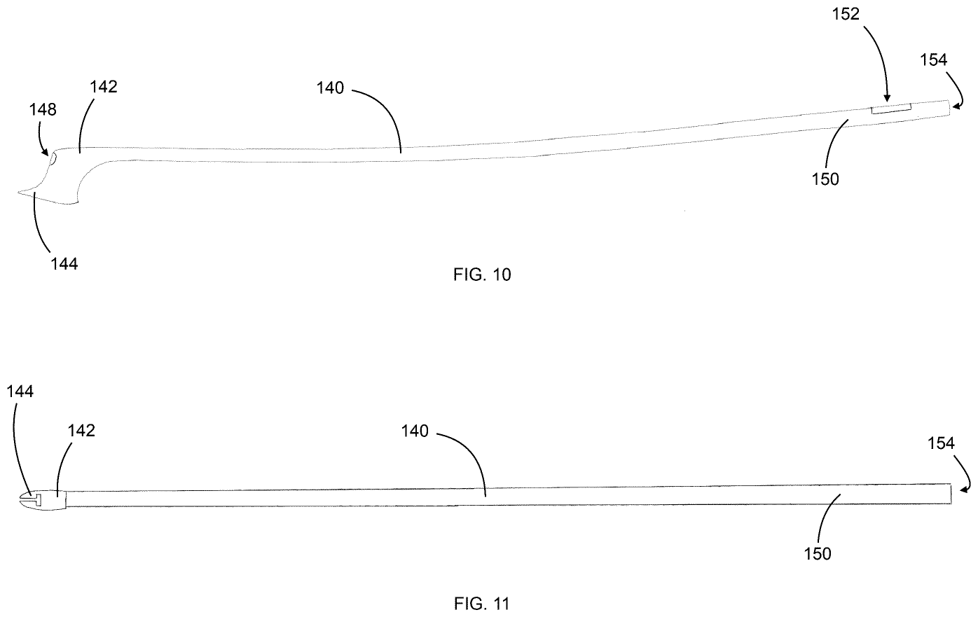

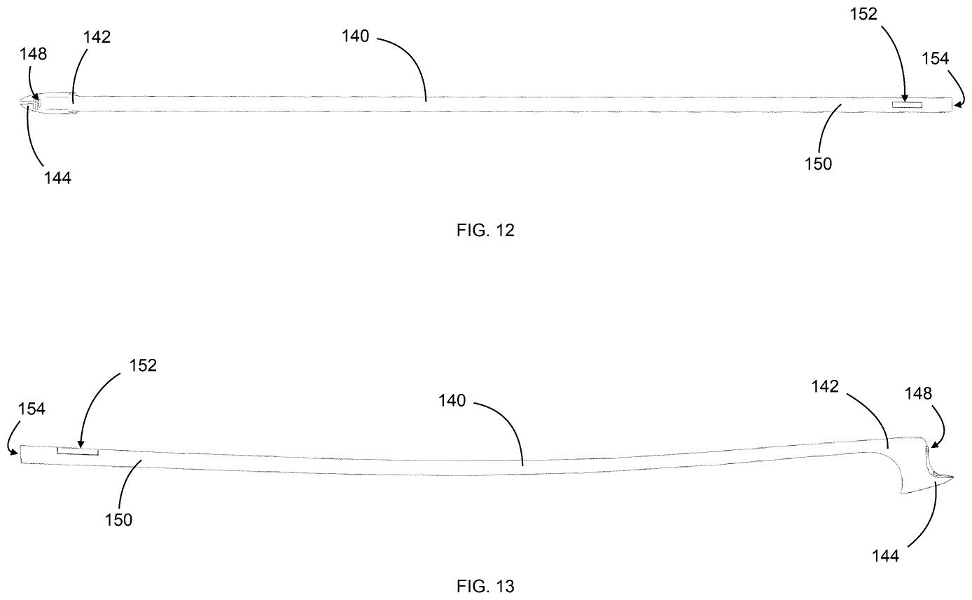

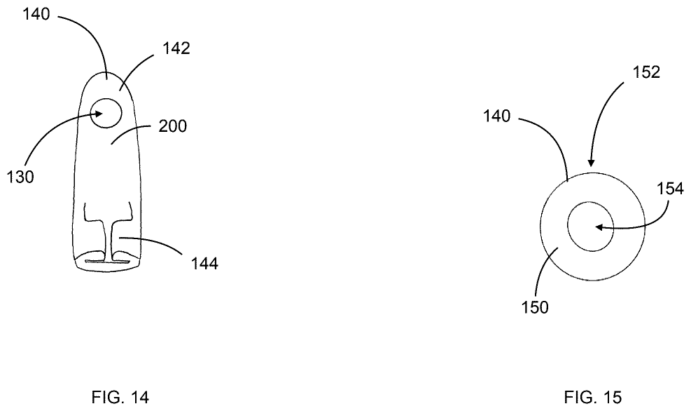

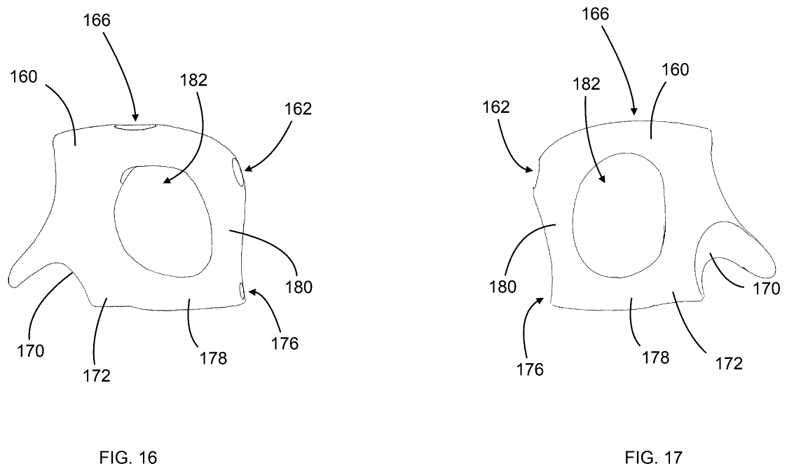

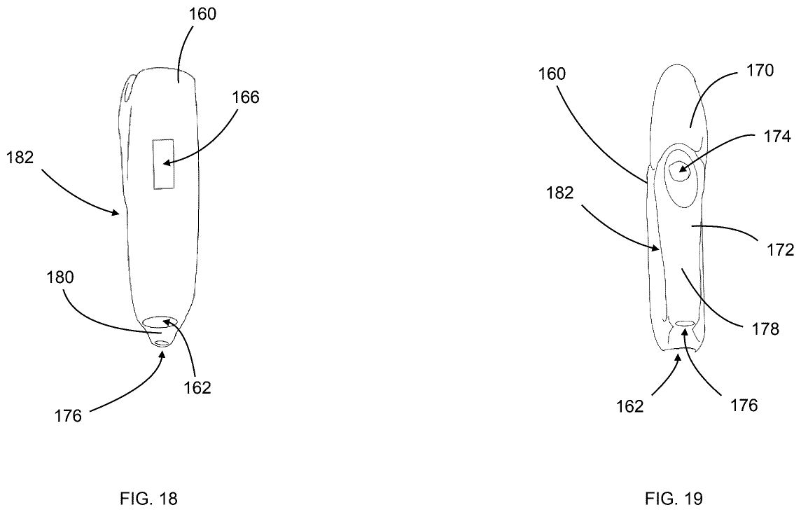

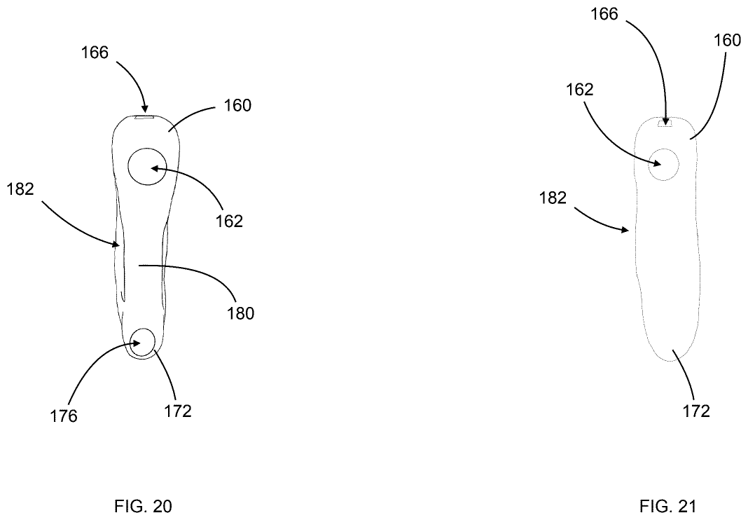

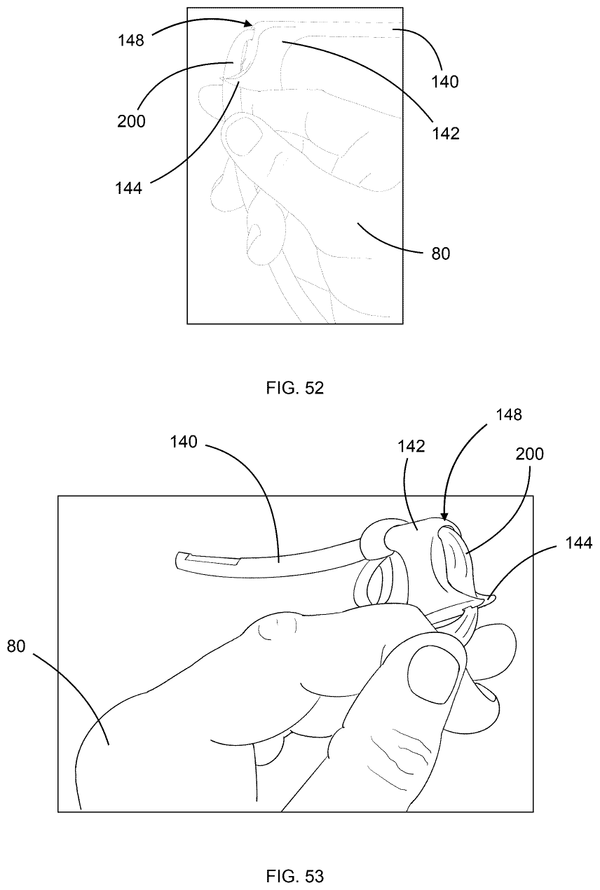

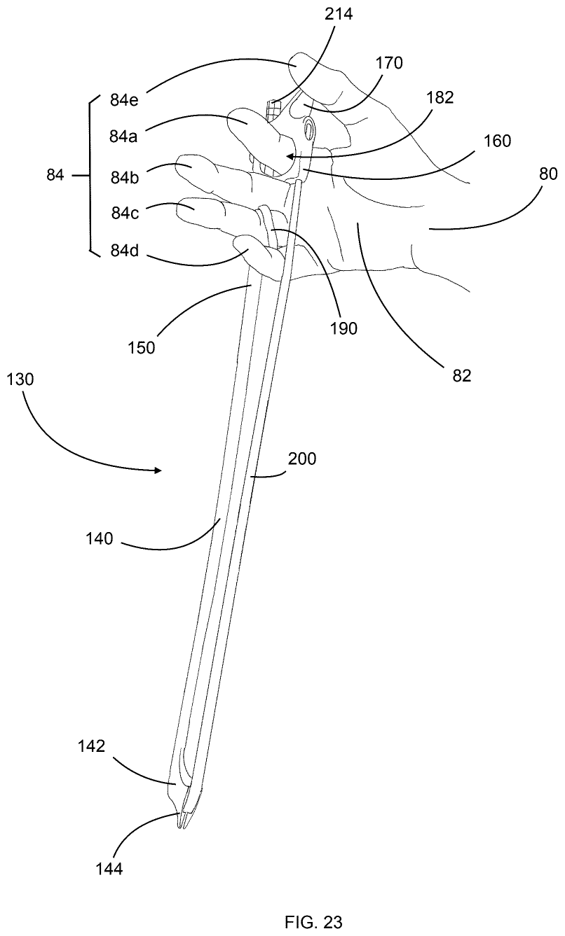

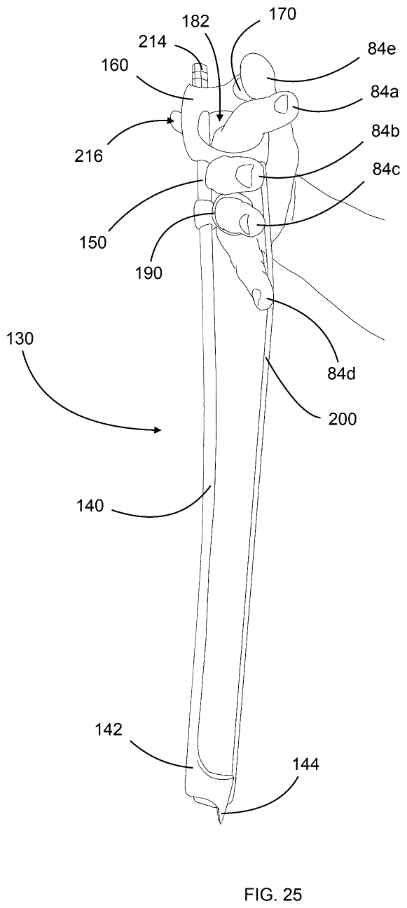

With reference to accompanying FIGS. 1 to 29, there is shown a bow device 130 according to a preferred embodiment of the invention. In FIGS. 1 to 29, the device 130 is adapted for use by musicians. As perhaps best shown in FIGS. 5-6, the device 130 includes a stick member 140, a frog member 160, and a hair portion 200. The device 130 also includes a loop member 190. The loop member 190 has a finger securing portion 194, and a stick securing portion 192 which attaches to the stick member 140.

The stick member 140 is preferably about forty (40) centimeters long and about three (3) centimeters high. The frog member 160 is preferably about seven (7) centimeters long and about six (6) centimeters high. The frog member 160 includes a shaft portion 178 and a pillar 180, and is shaped to define a finger hole 182.

As described elsewhere herein, and as shown in FIGS. 5-6, the device 130 includes a stick hole 162, a nut hole 166, and a screw hole 154, adapted to provide stability when the device 130 is in use. Channels 164, 168, 156 created in association with the machined holes 162, 166, 154 preferably serve as connection paths for a nut member 216 and a screw 214 to establish and maintain a secure connection between the stick member 140 and the frog member 160.

As described elsewhere herein, and as shown in FIGS. 5-6, the device 130 includes a hair portion 200—i.e., preferably, a prefabricated band of horsehair—along with a hair hole 176, a bifurcated tip notch 144, two aglets 204, 208, and two eyelets 174, 148. These parts preferably work together to establish and secure the hair portion 200 relative to the stick member 140.

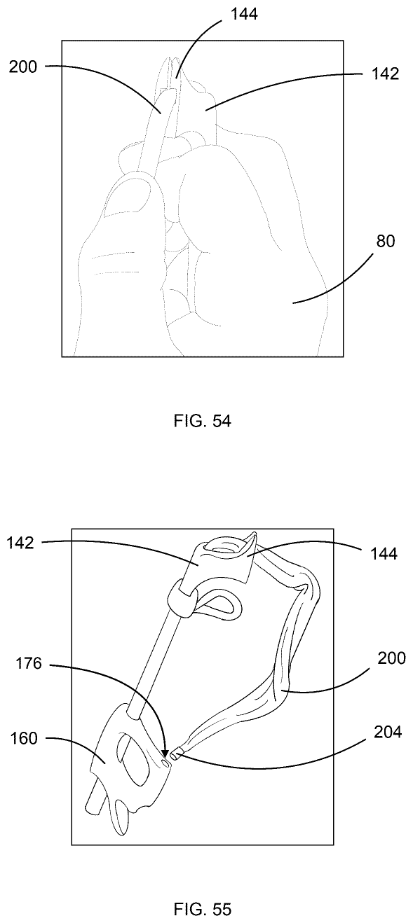

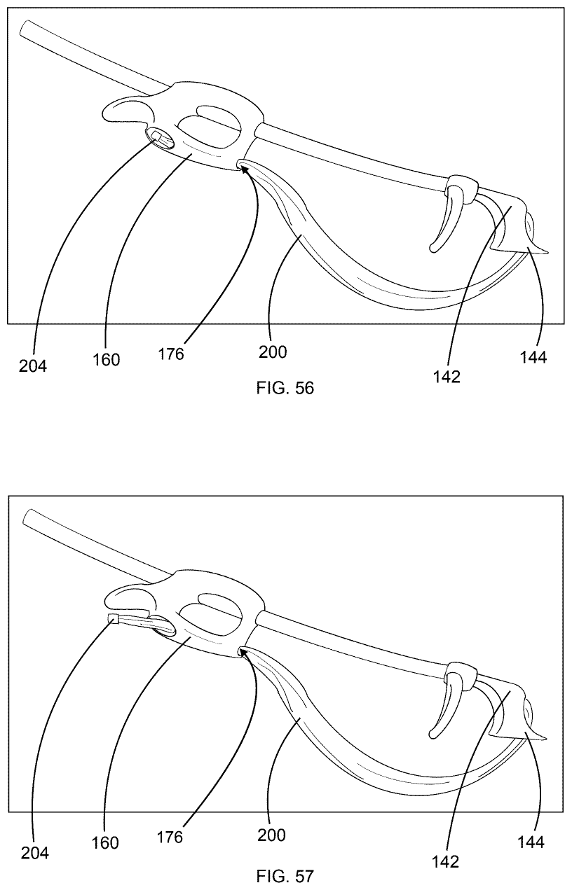

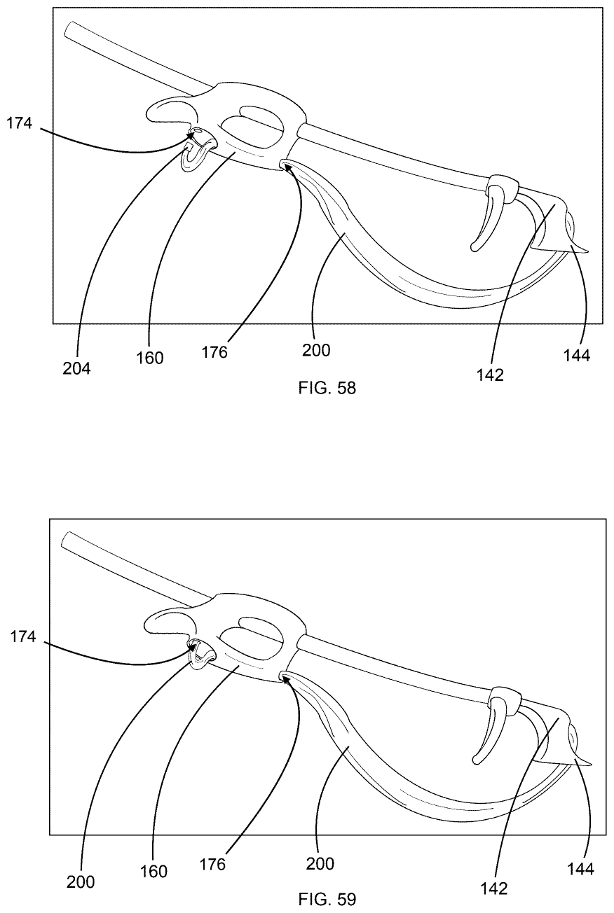

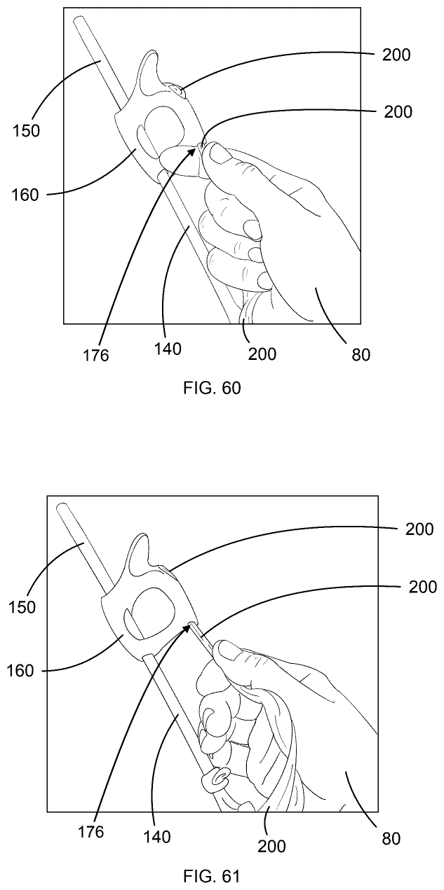

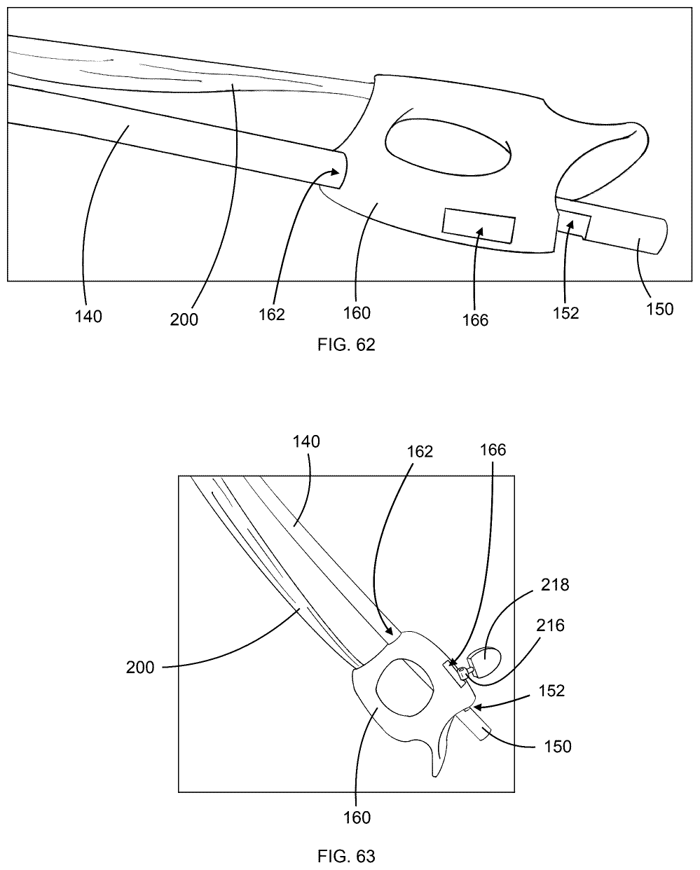

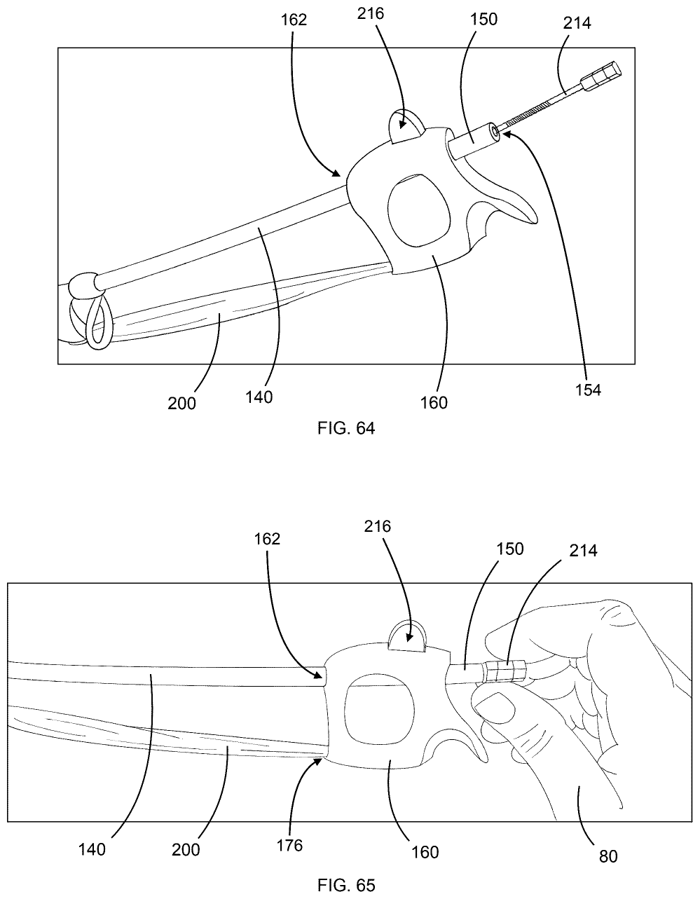

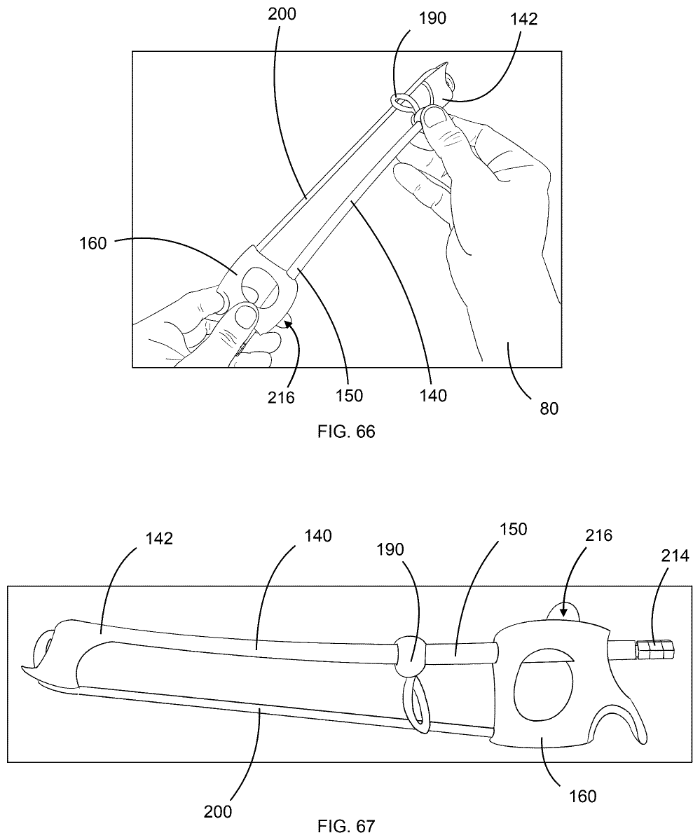

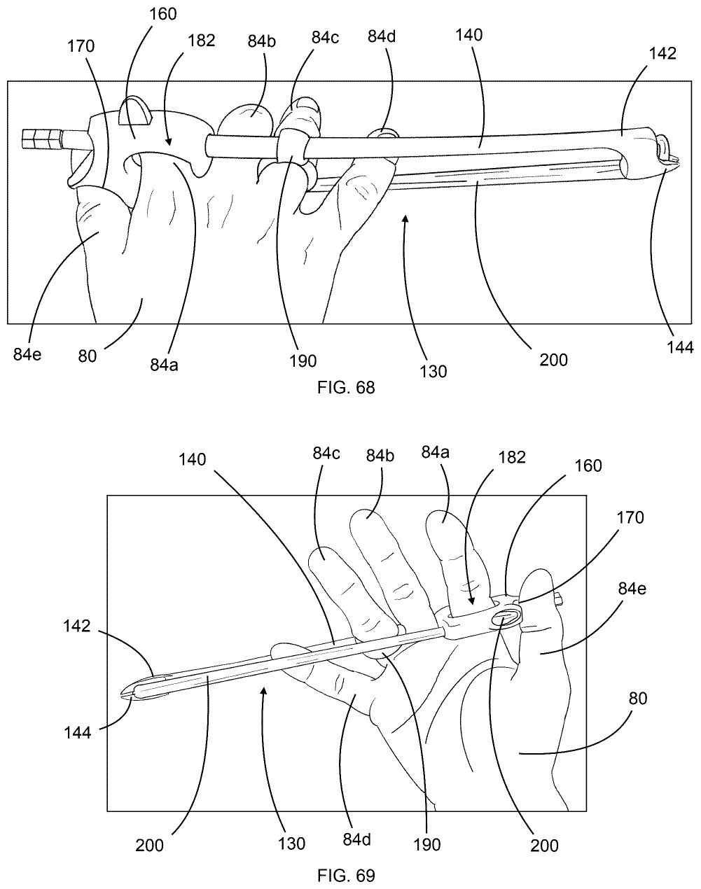

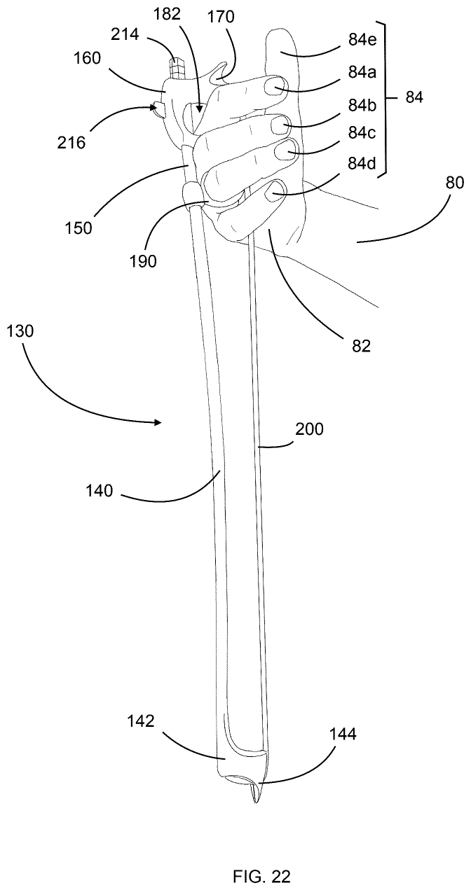

As perhaps best seen in FIGS. 22-25, the user's fingers 84 are preferably positioned between the stick member 140 and the hair portion 200 of the bow device 130. A user's index finger 84a preferably extends through the finger hole 182 in the frog member 160. The frog member 160 is then preferably held in the webbing between the user's index finger 84a and middle finger 84b, with the finger securing portion 194 of the loop member 190 worn and secured around the user's ring finger 84c to keep the bow device 130 in place and at the ready. The bow device 130 preferably enables the user 80 to passively hold the bow in the user's hand 82 (substantially perpendicular to a musical instrument 90) and to switch between playing styles.

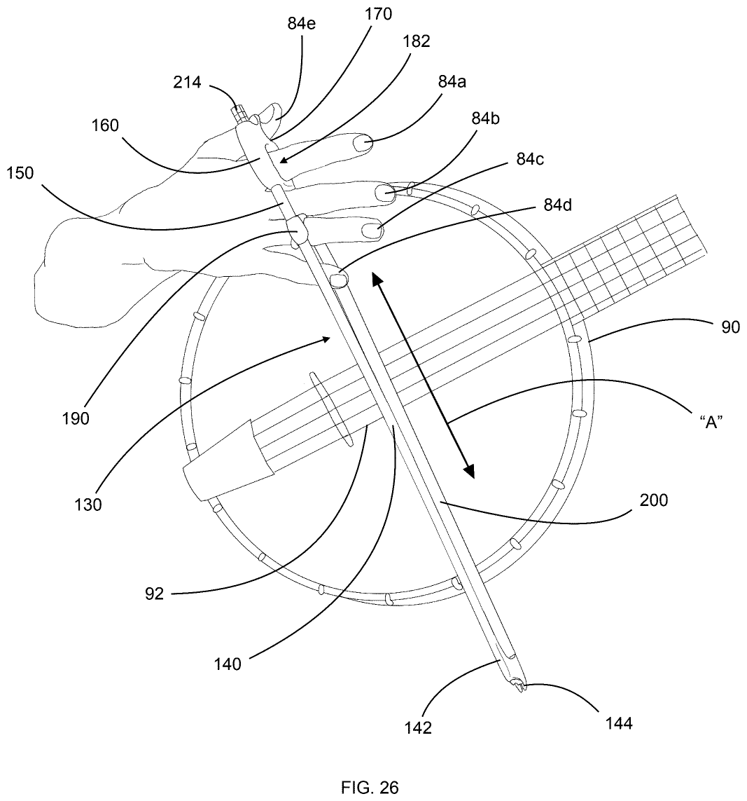

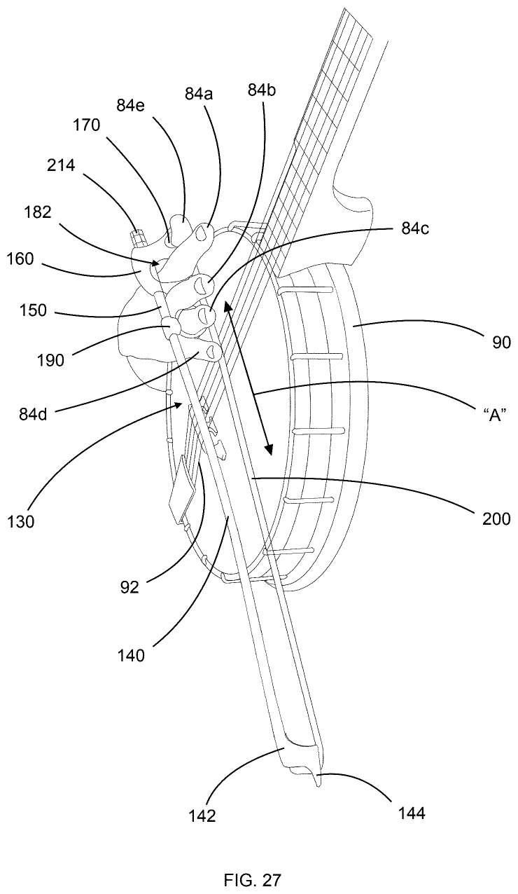

As perhaps best seen in FIGS. 26-27, the user 80 preferably spreads their fingers 84 wide and then draws/moves the bow device 130. The user's middle finger 84b and ring finger 84c are preferably braced against the stick member 140. The user's index finger 84a then preferably presses down on a shaft portion 178 at a bottom portion 172 of the frog member 160. The user's thumb 84e may then preferably hook into a crook portion 170 of the frog member 160. The user's pinky 84d then preferably presses on the hair portion 200, and guides the bow device 130 to strings 92 of the musical instrument 90.

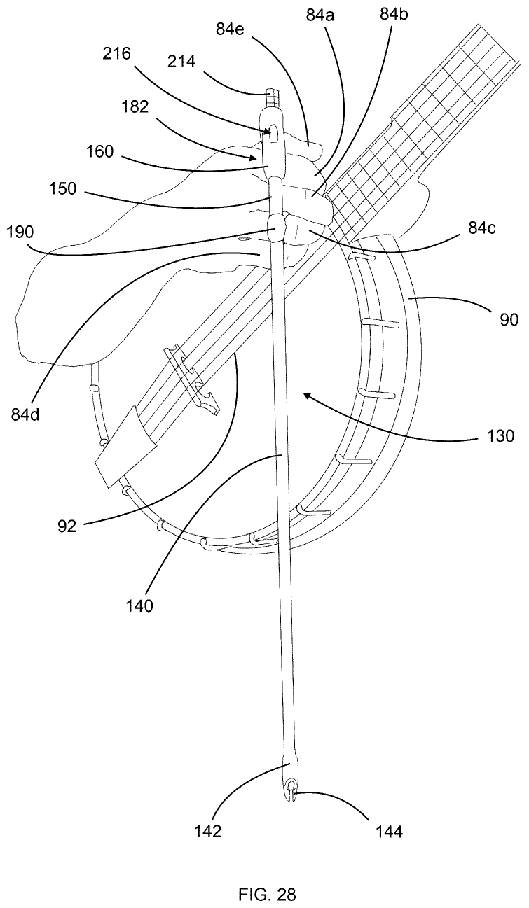

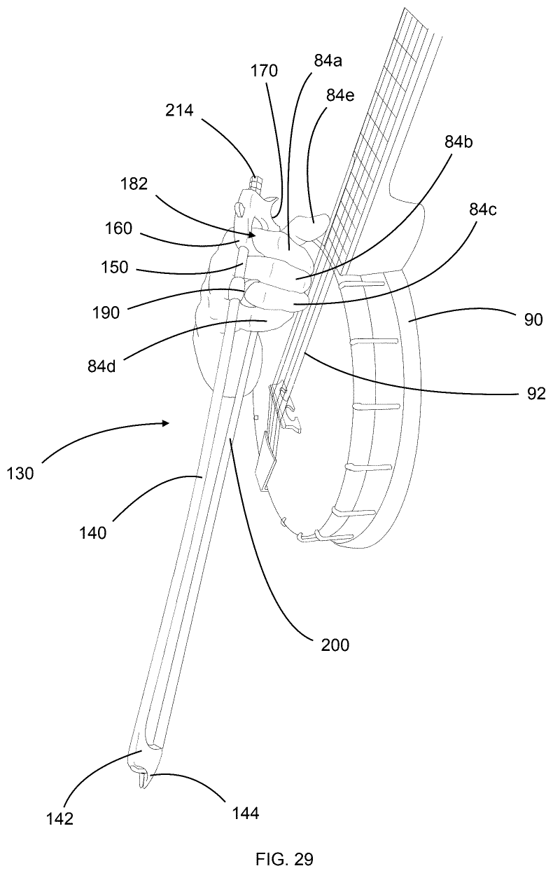

As perhaps best seen in FIGS. 28-29, the bow device 130 enables the user 80 to play the musical stringed instrument 90 with their fingers 84, as they would normally, with the bow device 130 between their fingers 84 and at the ready.

To describe a preferred embodiment of the invention in another way, the musical instrument bow device 130 includes the stick member 140, the frog member 160, the loop member 190, and the hair portion 200. The stick member 140 is preferably constructed from a wood material, and includes the distal tip portion 142 and the proximal end portion 150. The distal tip portion 142 is shaped to define the bifurcated tip notch 144 and the tip eyelet 148.

The frog member 160 securely engages the proximal end portion 150. The frog member 160 includes the frog eyelet 174 in a bottom portion 172 thereof, and has a stick hole 162 and a nut hole 166.

The proximal end portion 150 and the frog member 160 include fastening means 214, 216 for securing the stick member 140 to the frog member 160. The proximal end portion 150 has a screw hole 154 and a frog notch 152. The fastening means 214, 216 includes a screw 214 that fits in the screw hole 154, and a nut member 216 with a nut extension 218 that extends through the frog notch 152 and engages the screw 214.

Channels 164, 168, 156 extend from the stick hole 162, the nut hole 166, and the screw hole 154 respectively. The channels 164, 168, 156 serve as connection paths for the nut member 216 and the screw 214 to secure the stick member 140 to the frog member 160.

The loop member 190 is constructed from a rope-like or cord-like material, and securely engages the proximal end portion 150 between the frog member 160 and the distal tip portion 142.

The hair portion 200 preferably includes a prefabricated band of horsehair, and is substantially tautly and securely engaged between the frog member 160 and the bifurcated tip notch 144. The hair portion 200 frictionally engages the bifurcated tip notch 144 to help keep it taut.

The frog member 160 and the loop member 190 each passively and securely engage a respective one of a user's fingers 84, between the stick member 140 and the hair portion 200. The frog member 160 and the loop member 190 are spaced apart from one another. The frog member 160 passively and securely engages the user's index finger 84a. The loop member 190 passively and securely engages the user's ring finger 84c. The frog member 160 has a crook portion 170 that is adapted to engage the user's thumb 84e.

Opposing ends of the hair portion 200 are provided with the frog aglet 204 and the tip aglet 208. The tip aglet 208 securely and removably engages the tip eyelet 148, and the frog aglet 204 securely and removably engages the frog eyelet 174. As such, the hair portion 200 is securely engaged between the frog eyelet 174 and the tip eyelet 148. The tip eyelet 148, the frog eyelet 174, and the hair portion 200 together enable a simple and straightforward re-hairing of the bow device 130.

The hair portion 200 selectively engages the strings 92 of the musical instrument 90 for sliding movement relative thereto (in direction “A” as shown in FIGS. 26 and 27).

When the bow device 130 is removed from the strings 92, the bow device 130 is still secured to the user's fingers 84, at the ready to selectively re-engage the strings 92, while the user's fingers 84 are free to selectively pluck and strum the strings 92.

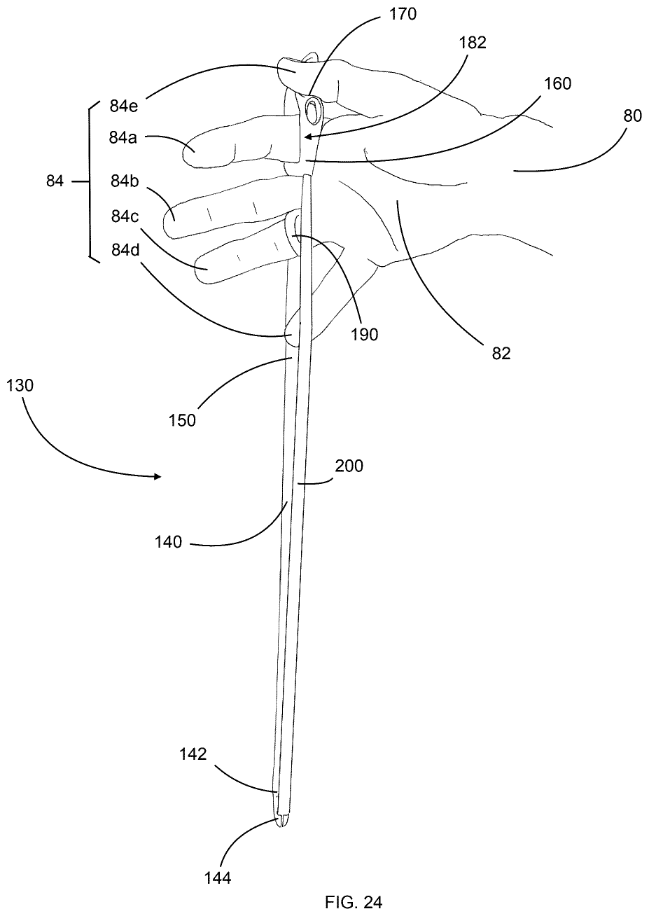

The bow device 130 enables ready transitions between bowing techniques (as shown in FIGS. 26 and 27) and plucking/strumming techniques (as shown in FIGS. 28 and 29) without adjusting the user's secure engagement of the bow device 130. When the user 80 spreads their fingers wide (as shown in FIGS. 24 to 27), the hair portion 200 can selectively engage the strings 92 of the musical instrument 90 for sliding movement relative thereto (in direction “A”as shown in FIGS. 26 and 27).

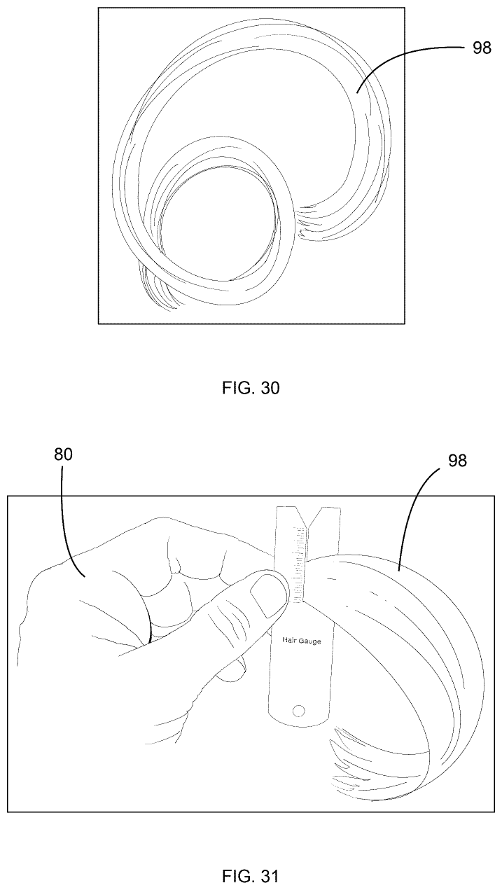

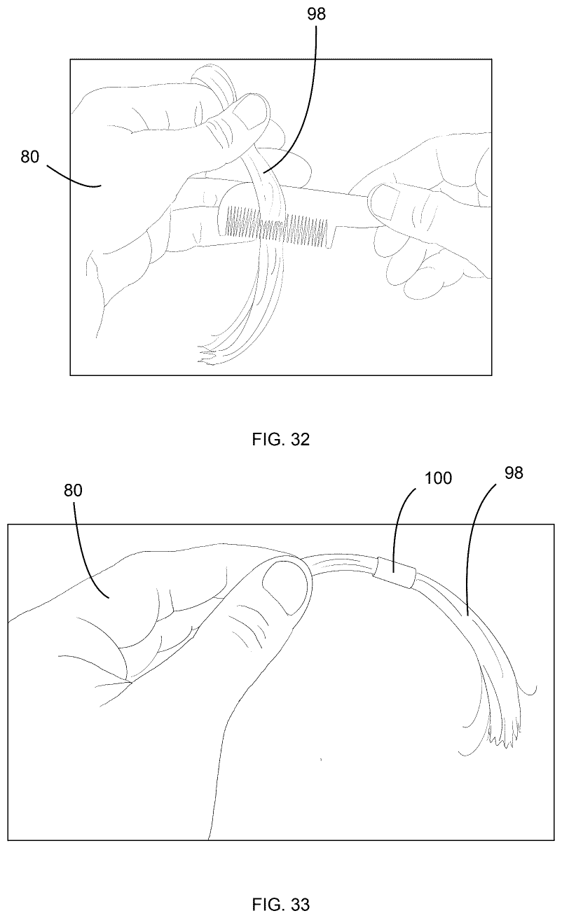

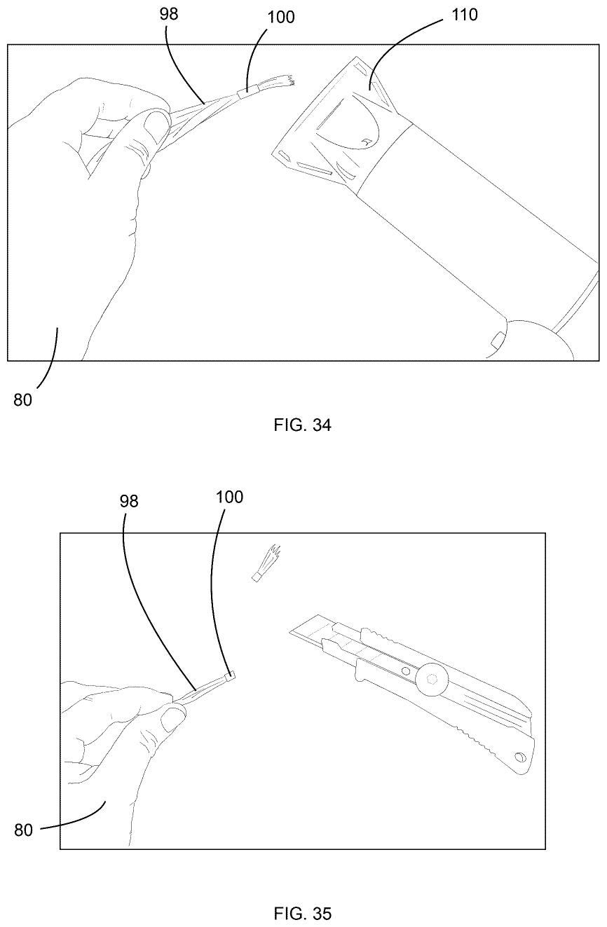

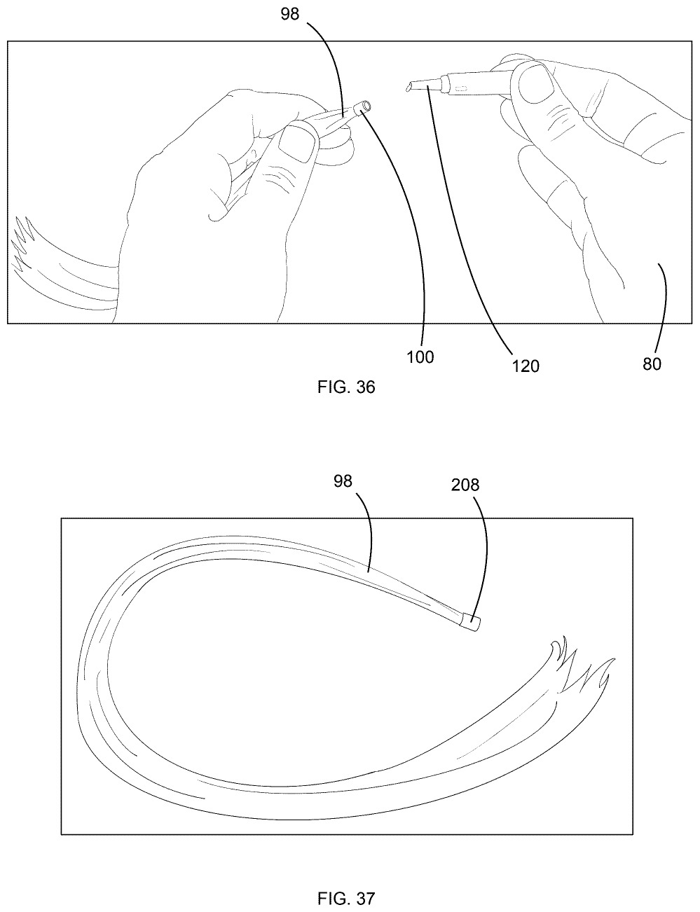

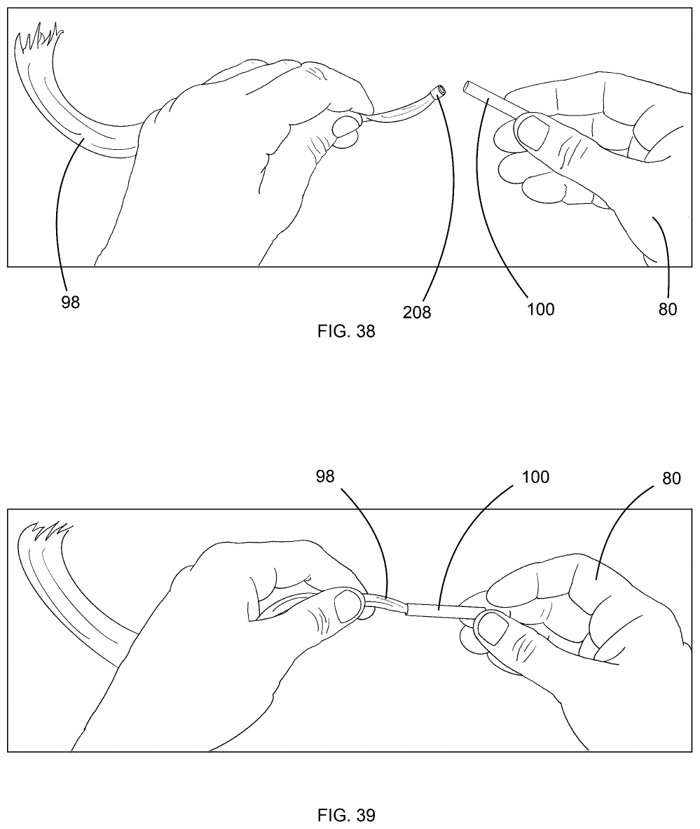

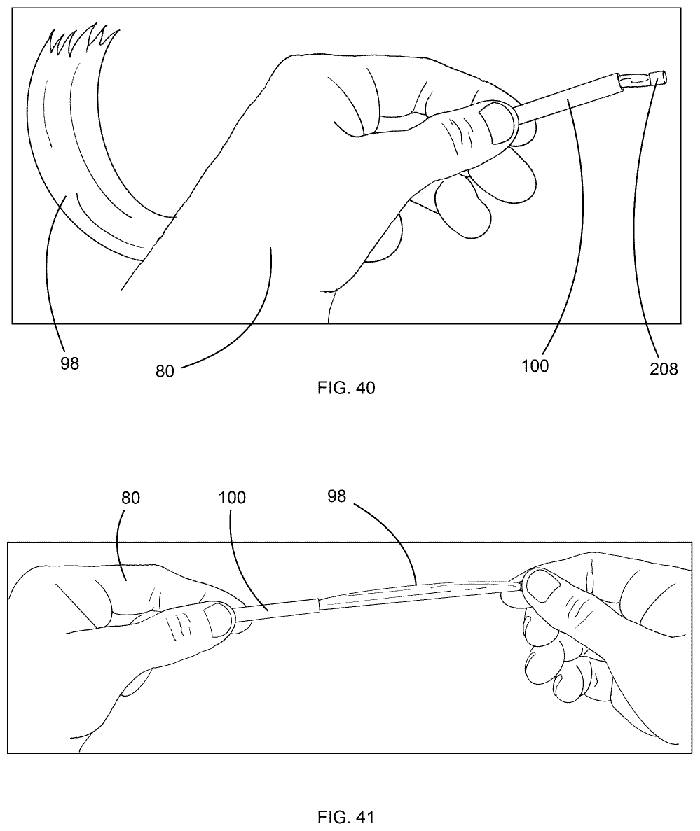

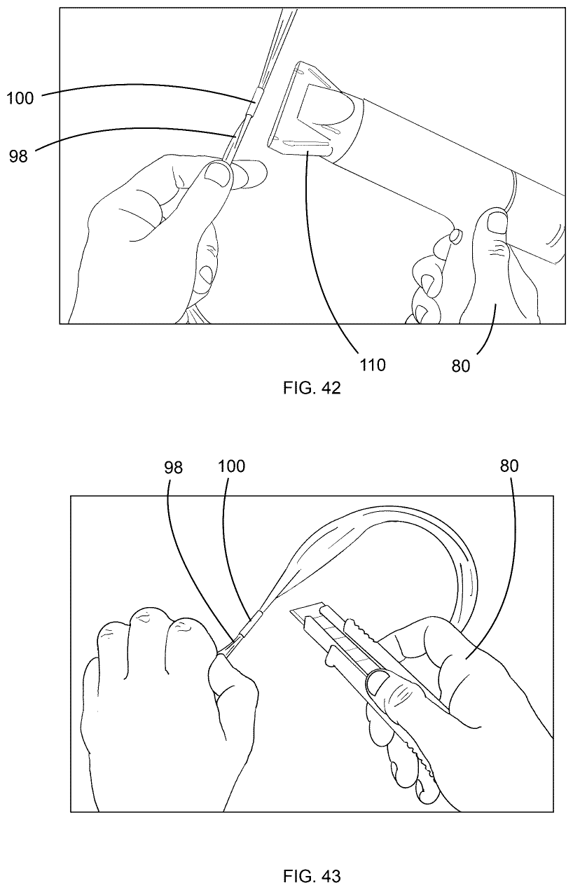

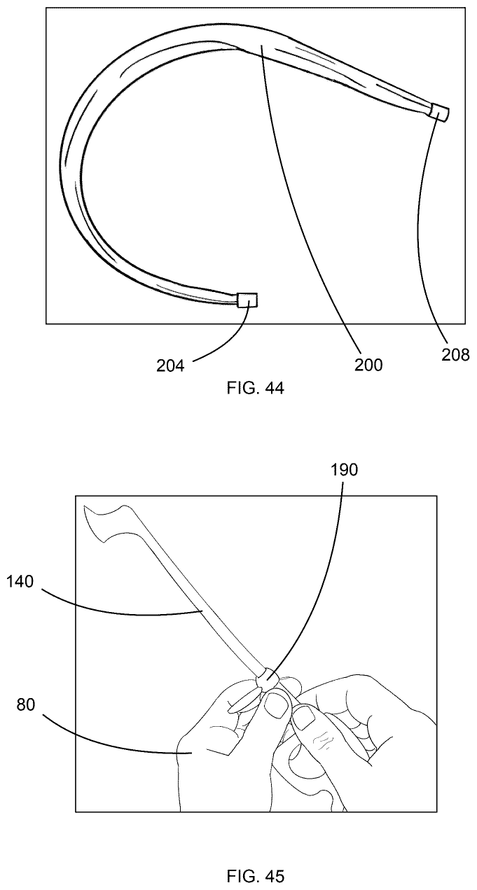

A method for hairing and/or re-hairing the bow device 130 is depicted in FIGS. 30-69. FIG. 30 depicts a piece of hair 98. FIG. 31 depicts measurement of the hair 98. FIG. 32 depicts combing of the hair 98. FIG. 33 depicts heat-shrinkable tubing 100 being slid over the piece of hair 98. FIG. 34 depicts a hair dryer 110 shrinking the tubing 100. FIG. 35 depicts a tip aglet 208 being trimmed. FIG. 36 depicts application of a fast-drying adhesive 120 to the trimmed tip aglet 208. FIG. 37 depicts the aglet-capped piece of hair 98. FIGS. 38-40 show a frog aglet 204 being slid over the piece of hair 200. FIG. 41 depicts the aglet-capped piece of hair 98 being measured to a desired length. FIG. 42 depicts the hair dryer 110 shrinking the tubing 100 down in order to cinch the hair 98 together. FIG. 43 depicts the aglet-capped piece of hair 98 being trimmed down again, with a fast-drying adhesive 120 being applied to bond the frog aglet 204 together. FIG. 44 depicts the hair portion 200 ready to be placed on the stick member 140 and the frog member 160.

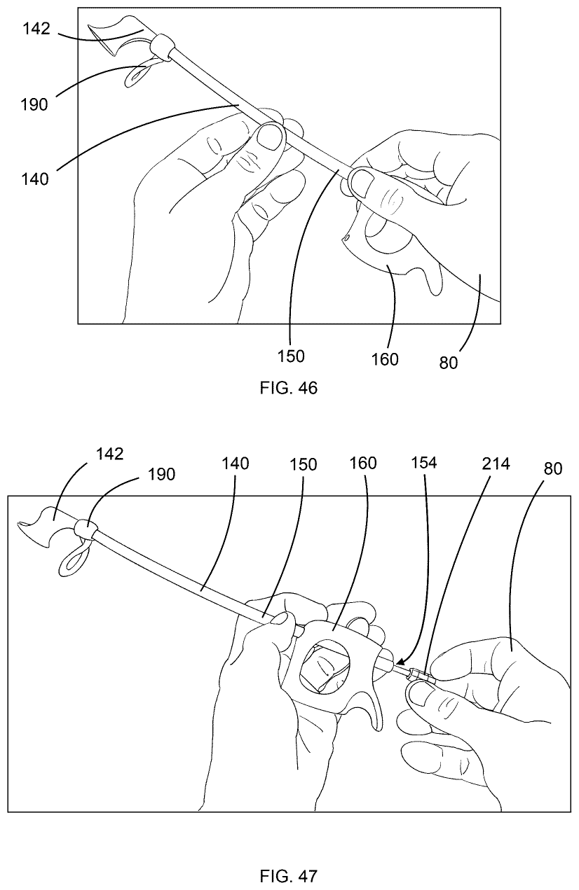

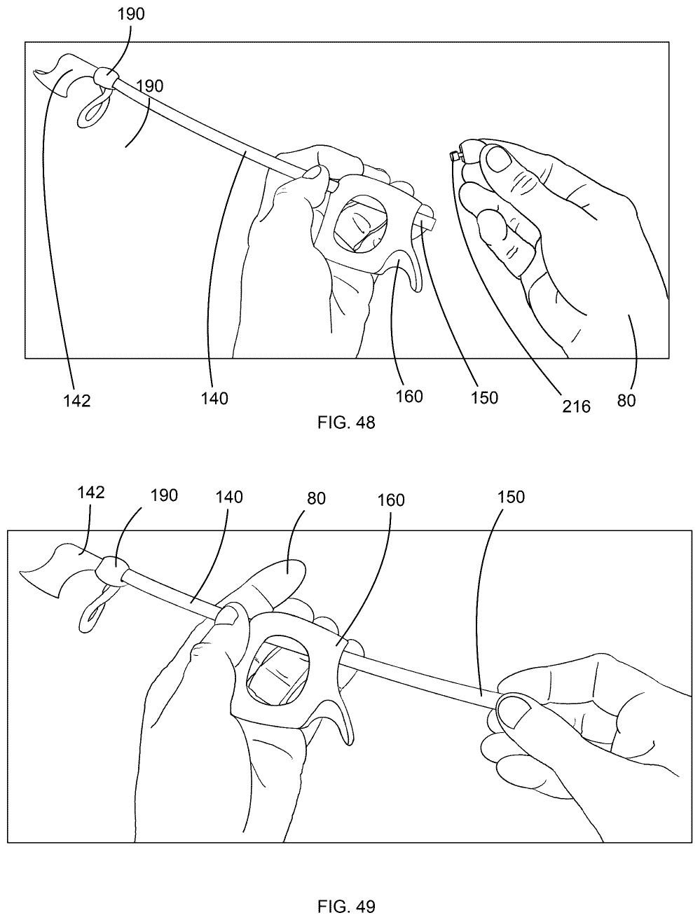

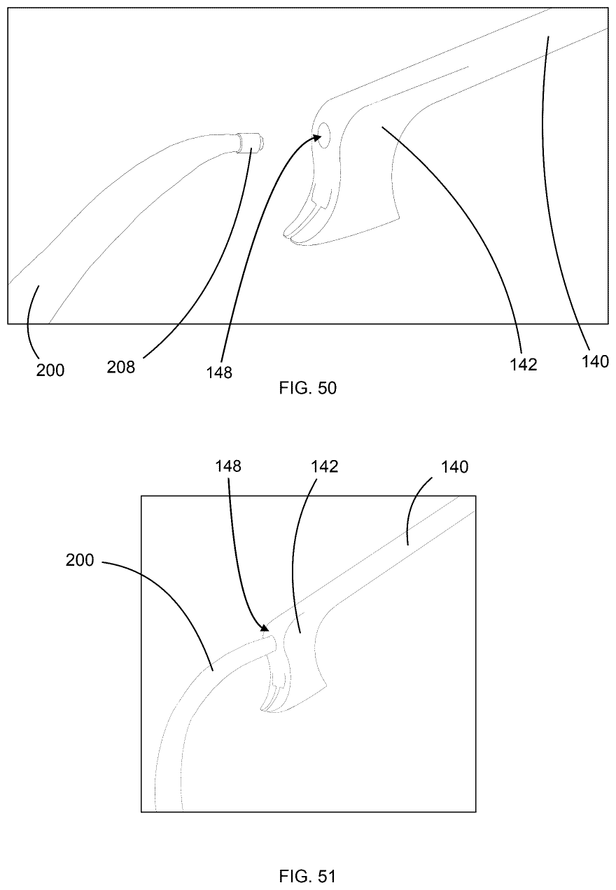

FIGS. 45-46 show the hair portion 200 being slid over the stick member 140. FIG. 47 depicts a screw 214 being unscrewed and removed from the stick member 140. FIG. 48 depicts a nut member 216 being removed. FIG. 49 depicts the frog member 160 being slid closer to the tip portion of the stick member 140 to create the bow device 130. FIG. 50 depicts the tip aglet 208 being pushed into the tip eyelet 148 of the distal tip portion 142 of the stick member 140. FIGS. 51-52 show the hair portion 200 being passed through the bifurcated tip notch 144 of the stick member 140. FIG. 53 depicts the hair portion 200 being pulled into the bifurcated tip notch 144 of the stick member 140. FIG. 54 depicts the hair portion 200 being pulled tight to secure it in place. FIG. 55 depicts the frog aglet 204 being inserted into the hair hole 176 of the frog member 160. FIGS. 56-57 show the frog aglet 204 being pushed through the hair hole 176 of the frog member 160, until it emerges through the other side. FIGS. 58-59 show the frog aglet 204 of the hair portion 200 (having just emerged through the other side of the hair hole 176) being bent and inserted into the frog eyelet 174 of the frog member 160. FIGS. 60-61 show the end of the hair portion 200 being pulled tight to secure it in place. FIG. 62 depicts the nut hole 166 of the frog member 160 being lined up to the frog notch 152 of the stick member 140. FIG. 63 depicts the nut member 216 being inserted into the frog member 160. FIG. 64 depicts the screw 214 being reinserted into the screw hole 154 until it catches on the nut member 216. FIG. 65 depicts the screw 214 being tightened until the hair portion 200 is taut. FIGS. 66-67 show the loop member 190 being slid into place. And, FIGS. 68-69 show the device 130 ready to use.

Preferably, to describe this method in another way, the re-hairing system first involves selecting, measuring, and combing straight a collection of horsehair 98, as perhaps best shown in FIGS. 30-32.

Then, the re-hairing system preferably involves sliding a piece of heat shrinkable tubing 100 over one end of the hair 98, shrinking the tubing 100 with a heat gun or hair dryer 110, trimming the tubing 100 to an appropriate length of about five (5) millimeters, and applying a fast drying adhesive 120 to bond the newly formed tip aglet 208 together, as perhaps best seen in FIGS. 33-37.

Following the above step, a user 80 preferably then slides a second piece of heat shrinkable tubing 100 over the other end of the hair 98, and then measures, shrinks, and trims the tubing 100 to form a frog aglet 204, perhaps best seen in FIGS. 38-44.

After the hair portion 200 has been organized into a band as described elsewhere herein, the user 80 preferably slides the loop member 190, over the unattached stick member 140, towards the distal tip portion 142, as perhaps best seen in FIGS. 45-46.

The frog member 160 may then be slid over the stick member 140, alongside which the nut member 216 and the screw 214 may preferably be removed from the frog member 160, as perhaps best seen in FIGS. 47-49.

A tip aglet 208 may then be pushed into the tip eyelet 148, passed through the bifurcated tip portion, and pulled tight to establish a stable and secure fit, as perhaps best seen in FIGS. 50-53.

The frog aglet 204 may then be inserted into the hair hole 176, pushed through until emerging on the other side of the hair hole 176, bent and inserted into the frog eyelet 174, and then pulled tight, to establish a stable and secure fit (as perhaps best seen in FIGS. 54-61).

Once the hair portion 200 is secured, the user 80 should then preferably reinsert the nut member 216 and the screw 214 back into the frog member 160, and slide the loop member 190 into place, as perhaps best seen in FIGS. 62-67.

Preferably, an application of rosin will complete the re-hairing process of the device 130, as perhaps best seen in FIGS. 68-69.

It should perhaps be expressly noted that, preferably, the fast-drying adhesive 120 is effective to securely bond the tubing to the hair portion, and to securely bond the hair together. The bow device 130 is for use with bowing techniques, and is also adapted for substantially seamless transition for plucking/strumming techniques, and has a comparable cost to a violin bow, with a similar learning curve.

Preferably, the invention helps provide one or more advantages over the prior art—and/or helps to solve, obviate, and/or mitigate one or more problems associated with the prior art—including (but not limited to) those described below and/or elsewhere herein.

As detailed herein, the invention preferably provides one or more of the following: (a) increased availability of musical instrument bows in the market; (b) increased versatility of use of musical instrument bows; and/or (c) a simplified procedure for re-hairing the device 130, enabling laypersons to re-hair their musical instrument bows themselves.

Further, the invention may preferably afford enhanced efficiency, adaptability, and/or safety features for various musical, recording, and/or performance environments.

The invention is contemplated for use by or in association with musical instrument bows, as described above. The invention, however, is not so limited. And, in any event, other embodiments, which fall within the scope of the invention, may be provided.

Future improvements or modifications to the idea may include, among other things, one or more of the following: (a) leather padding added to the stick member 140, e.g., for enhanced comfort; (b) a sheath-like covering added to the hair portion 200, e.g., to preserve it for longer, (c) a ferrule, e.g., to help spread the hair portion 200 out in a flat ribbon where it exits the frog member 160, and/or (d) an expanded re-hairing system which may be applied to violin bows.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations and/or steps according to the invention are not specifically referenced in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims hereof.

1. A musical instrument bow device, comprising:
(a) a stick member having a distal tip portion and a proximal end portion;
(b) a frog member securely engaging the proximal end portion;
(c) a loop member securely engaging the proximal end portion, between the frog member and the distal tip portion; and
(d) a hair portion which is substantially tautly and securely engaged between the frog member and the distal tip portion, and adapted to selectively engage one or more strings of a musical instrument for sliding movement relative thereto;
wherein the frog member and the loop member are each adapted to passively and securely engage a respective one of a user's fingers, between the stick member and the hair portion; and
wherein, when the musical instrument bow device is removed from the strings, the musical instrument bow device is still secured to the user's fingers, at the ready to selectively re-engage the strings, while the user's fingers are free to selectively pluck and strum the strings; and
wherein the musical instrument bow device enables ready transitions between bowing techniques and plucking/strumming techniques without adjusting the user's secure engagement of the musical instrument bow device.

2. The musical instrument bow device of claim 1, wherein the frog member and the loop member are spaced apart from one another; wherein the frog member is adapted to passively and securely engage the user's index finger, and the loop member is adapted to passively and securely engage the user's ring finger; and wherein the frog member and the loop member are adapted such that, when the user spreads their fingers wide, the hair portion is adapted to selectively engage the strings of the musical instrument for sliding movement relative thereto.

3. The musical instrument bow device of claim 1, wherein the frog member has a crook portion that is adapted to engage the user's thumb.

4. The musical instrument bow device of claim 1, wherein the distal tip portion is shaped to define a bifurcated tip notch, wherein the hair portion extends between the bifurcated tip notch and frictionally engages the bifurcated tip notch to keep the hair portion taut.

5. The musical instrument bow device of claim 1, wherein the distal tip portion is shaped to define a tip eyelet, and the frog member is shaped to define a frog eyelet, wherein opposing ends of the hair portion are provided with a frog aglet and a tip aglet, and wherein the tip aglet securely engages the tip eyelet, and the frog aglet securely engages the frog eyelet, such that the hair portion is securely engaged between the frog eyelet and the tip eyelet.

6. The musical instrument bow device of claim 5, wherein the tip aglet removably engages the tip eyelet, and the frog aglet removably engages the frog eyelet, such that the tip eyelet, the frog eyelet, and the hair portion together enable a simple and straightforward re-hairing of the musical instrument bow device.

7. The musical instrument bow device of claim 5, wherein the frog eyelet is shaped in a bottom portion of the frog member.

8. The musical instrument bow device of claim 1, wherein the proximal end portion and the frog member comprise fastening means for securing the stick member to the frog member.

9. The musical instrument bow device of claim 8, wherein the fastening means comprises a screw provided on the proximal end portion and a nut member on the frog member.

10. The musical instrument bow device of claim 9, wherein the proximal end portion is shaped to define a frog notch, wherein the nut member extends through the frog notch and engages the screw provided on the proximal end portion.

11. The musical instrument bow device of claim 9, wherein the frog member is shaped to define a stick hole and a nut hole, and the stick member is shaped to define a screw hole; wherein channels are shaped in association with each of the stick hole, the nut hole, and the screw hole; and wherein the channels serve as connection paths for the nut member and the screw to secure the stick member to the frog member.

12. The musical instrument bow device of claim 1, wherein the hair portion comprises a prefabricated band of horsehair.

13. The musical instrument bow device of claim 1, wherein the stick member is constructed from one or more wood materials.

14. The musical instrument bow device of claim 1, wherein the loop member is constructed from one or more rope-like or cord-like materials.

15. The musical instrument bow device of claim 1, wherein the frog member is about 7 centimeters long and about 6 centimeters high.

16. A method for manufacturing a musical instrument bow device, comprising:
(a) providing a stick member having a distal tip portion and a proximal end portion;
(b) providing a frog member and a loop member, and securely engaging the frog member and the loop member on the proximal end portion; and
(c) providing a hair portion, which is substantially tautly and securely engaged between the frog member and the distal tip portion;
wherein the frog member and the loop member are each adapted to passively and securely engage a respective one of a user's fingers, between the stick member and the hair portion; and
wherein, when the musical instrument bow device is removed from the strings, the musical instrument bow device is still secured to the user's fingers, at the ready to selectively re-engage the strings, while the user's fingers are free to selectively pluck and strum the strings; and
wherein the musical instrument bow device enables ready transitions between bowing techniques and plucking/strumming techniques without adjusting the user's secure engagement of the musical instrument bow device.

17. The method of claim 16, wherein in step (a), the distal tip portion is shaped to define a bifurcated tip notch, and in step (c), the hair portion extends between the bifurcated tip notch and frictionally engages the bifurcated tip notch to keep the hair portion taut.

18. The method of claim 16, wherein the distal tip portion is shaped to define a tip eyelet, and the frog member is shaped to define a frog eyelet; wherein opposing ends of the hair portion are provided with a frog aglet and a tip aglet; and wherein, in step (c), the tip aglet securely engages the tip eyelet, and the frog aglet securely engages the frog eyelet, such that the hair portion is securely engaged between the frog eyelet and the tip eyelet.

19. The method of claim 18, wherein in step (c), the tip aglet removably engages the tip eyelet, and the frog aglet removably engages the frog eyelet; such that the tip eyelet, the frog eyelet, and the hair portion together enable a simple and straightforward re-hairing of the musical instrument bow device.

20. The method of claim 16, further comprising steps, before step (c), of forming aglets on opposing ends of the hair portion by:
(d) sliding a piece of heat shrinkable tubing over each of the opposing ends of the hair portion;
(e) shrinking the tubing with a heat gun or hair dryer, such that the tubing engages the hair portion;
(f) trimming the tubing and the hair portion to an appropriate length; and
(g) applying a fast-drying adhesive to securely bond the tubing to the hair portion.
